(19) United States
(12) Patent Application Publication
(10) Pub. No.: US 2008/0135481 A1
(43) Pub. Date: Jun. 12, 2008

(54) POLYARYLETHERNITRILE HOLLOW FIBER MEMBRANES

(75) Inventors: Daniel Steiger, Clifton Park, NY (US); Yanshi Zhang, Schenectady, NY (US); Gary William Yeager, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/567,487

(22) Filed: Dec. 6, 2006

(51) Int. Cl. B01D 61/24; B01D 61/28

(52) U.S. Cl. 210/646; 210/500.23; 210/500.28

(57) ABSTRACT

A method for hemodialysis and hemofiltration includes contacting blood with a porous membrane in a hollow fiber or flat sheet configuration. The membrane comprises a polyarylethernitrile sulfone having structural units of formula I

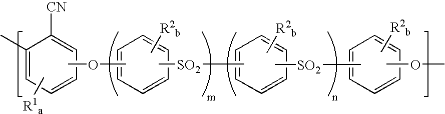

wherein
R¹ and R² are independently H, nitro, a C₁-C₁₂ aliphatic radical, a C₃-C₁₂ aromatic radical, or a combination thereof;
a is 0, 1, 2 or 3;
b is 0, 1, 2, 3 or 4; and
m and n are independently 0 or 1.

### BACKGROUND

The invention relates generally to methods and apparatuses for hemodialysis and hemofiltration.

In recent years, porous membranes, either in hollow fiber or flat sheet configurations have found use in hemodialysis and hemofiltration. Hemodialysis membranes are porous membranes permitting the passage of low molecular weight solutes, typically less than 5,000 Daltons, such as urea, creatinine, uric acid, electrolytes and water, yet preventing the passage of higher molecular weight proteins and blood cellular elements. Hemofiltration, which more closely represents the filtration in the glomerulus of the kidney, requires even more permeable membranes allowing complete passage of solutes of molecular weight of less than 50,000 Daltons, and, in some cases, less than 20,000 Daltons. The polymers used in these membranes must possess excellent mechanical properties so as to support the fragile porous membrane structure during manufacture and use. In addition, the polymer must have adequate thermal properties so as not to degrade during high temperature steam sterilization processes. Furthermore these membranes must have excellent biocompatibility, such that protein fouling is minimized and thrombosis of the treated blood does not occur. Though polysulfones have the mechanical and thermal properties necessary for these applications, they are insufficiently hydrophilic. To improve their hydrophilicity, polysulfones have been blended with hydrophilic polymers such as polyvinylpyrollidinone (PVP). However, since PVP is water soluble it is slowly leached from the porous polymer matrix creating product variability. Notwithstanding, the method of blending polysulfone with a hydrophilic polymer such as PVP is a commercially used process for producing hydrophilic porous polysulfone membranes for hemofiltration and hemodialysis.

Thus porous membranes possessing excellent thermal and mechanical properties and excellent biocompatibility for hemodialysis and hemofiltration are desired. In addition, polymers capable of being fabricated into porous membranes that possess sufficient hydrophilicity to obviate the need for blending with a hydrophilic polymers is also desired. Finally polymers which are more hydrophilic than polysulfone yet not water soluble, which may induce hydrophilicity to the porous polysulfone membranes without undesirably leaching from the membrane are also sought.

### BRIEF DESCRIPTION

In one aspect, the present invention relates to porous membranes for hemodialysis or hemofiltration. The membranes are composed of a polyethernitrile comprising structural units of formula I

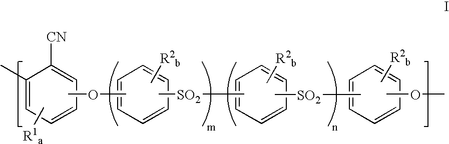

wherein
R¹ and R² are independently H, nitro, a C₁-C₁₂ aliphatic radical, a C₃-C₁₂ aromatic radical, or a combination thereof;
a is 0, 1, 2 or 3;
b is 0, 1, 2, 3 or 4; and
m and n are independently 0 or 1.

In another aspect, the present invention relates to methods for hemodialysis or hemofiltration, said method comprising contacting blood with a porous hollow fiber or flat sheet membrane comprising a polyarylethernitrile having structural units of formula I.

In another aspect, the present invention relates to dialysis apparatus comprising a plurality of porous hollow fibers comprising a polyarylethernitrile having structural units of formula I.

### DETAILED DESCRIPTION

In one aspect the present invention relates to methods for hemodialysis and hemofiltration. Hemodialysis is the process of removing substances through the blood by their unequal penetration through a permeable membrane. Hemodialysis membranes permit the passage of low molecular weight solutes, typically less than 5,000 Daltons, such as urea, creatinine, uric acid, electrolytes and water, but prevent the passage of higher molecular weight proteins and blood cellular elements. Hemofiltration, which more closely represents the filtration in the glomerulus of the kidney, requires more highly permeable membranes which allow complete passage of solutes of molecular weight of less than 50,000 Daltons, and, in some cases, less than 20,000 Daltons. Most dialyzers in use are of a hollow fiber design though designs employing flat sheet membranes are also commercially available with blood and dialysate generally flowing in opposite directions. Both methods comprise contacting blood with a porous hollow fiber membrane. The porous membrane of this invention includes a polyarylethernitrile of structure I, Ideally as either a hollow fiber or flat sheet configuration. The porous membrane comprises a polyarylethernitrile having structural units of formula I.

In another aspect, the present invention relates to porous membranes for hemodialysis and hemofiltration comprising a polyarylethernitrile having structural units of formula I.

Polyarylethernitriles are typically solvent resistant polymers with high glass transition temperature and/or melting point. The polymers may be produced by reacting a dihalobenzonitrile with an aromatic dihydroxy compound in a polar aprotic solvent in the presence of a basic salt of an alkali metal, and optionally, in the presence of catalysts.

The dihalobenzonitrile compounds may generally be represented by the formula

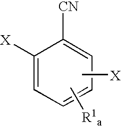

wherein X is a halogen, and R¹, a and c are as defined earlier. Polyarylethernitriles are typically solvent resistant polymers with high glass transition temperature and/or melting point. The polymers may be produced by reacting a dihalobenzonitrile with an aromatic dihydroxy compound in roughly equimolar amounts at elevated temperature in a polar aprotic solvent generally in the presence of an alkali metal compound, and optionally, in the presence of catalysts. An alternative solvent is a halogenated aromatic solvent.

Some examples of the dihalobenzonitrile monomers useful in the present invention include a member or members selected from the group consisting of 2,4-dihalobenzonitrile, 2,5-dihalobenzonitrile, and 2,6-dihalobenzonitrile ideally a member or members selected from 2,4-dichlorobenzonitrile, 2,5-dichlorobenzonitrile, and 2,6-dichlorobenzonitrile 2,4-difluorobenzonitrile, 2,5-difluorobenzonitrile, and 2,6-difluorobenzonitrile.

Aromatic dihydroxy compounds that may used to make the polyarylethernitrile of this invention include those represented by the formula

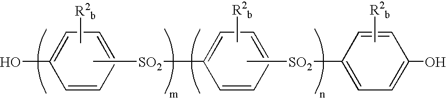

wherein R², b, m and n are as previously defined. Exemplary aromatic dihydroxy compounds include, but are not limited to, 4,4′-dihydroxyphenyl sulfone, 2,4′-dihydroxyphenyl sulfone, 3,3′-dihydroxydiphenylsulfone, 2,2′-dihydroxydiphenylsulfone, bis(3,5-dimethyl-4-hydroxyphenyl)sulfone, particularly 4,4′-dihydroxydiphenylsulfone.

A basic salt of an alkali metal compound may be used to effect the reaction between the dihalobenzonitriles and aromatic dihydroxy compounds, and is not particularly limited so far as it can convert the aromatic dihydroxy compound to its corresponding alkali metal salt. Exemplary compounds include alkali metal hydroxides, such as, but not limited to, lithium hydroxide, sodium hydroxide, potassium hydroxide, rubidium hydroxide, and cesium hydroxide; alkali metal carbonates, such as, but not limited to, lithium carbonate, sodium carbonate, potassium carbonate, rubidium carbonate, and cesium carbonate; and alkali metal hydrogen carbonates, such as but not limited to lithium hydrogen carbonate, sodium hydrogen carbonate, potassium hydrogen carbonate, rubidium hydrogen carbonate, and cesium hydrogen carbonate. Combinations of compounds may also be used to effect the reaction.

Some examples of the aprotic polar solvent that may be effectively used to make the polyarylethernitrile include N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone (NMP), N-ethyl-2-pyrrolidone, N-isopropyl-2-pyrrolidone, N-isobutyl-2-pyrrolidone, N-n-propyl-2-pyrrolidone, N-n-butyl-2-pyrrolidone, N-cyclohexyl-2-pyrrolidone, N-methyl-3-methyl-2-pyrrolidone, N-ethyl-3-methyl-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethylsulfoxide (DMSO), diethylsulfoxide, sulfolane, 1-methyl-1-oxosulfolane, 1-ethyl-1-oxosulfolane, 1-phenyl-1-oxosulfolane, N,N′-dimethylimidazolidinone (DMI), diphenylsulfone, and combinations thereof. The amount of solvent to be used is ideally an amount which is sufficient to dissolve the respective compounds dihaloarmatic compound and aromatic dihydroxy compound.

The reaction may be conducted at a temperature ranging from about 100° C. to about 300° C., ideally from about 120 to about 200° C., more preferably about 150 to about 200° C. Often when thermally unstable or reactive groups are present in the monomer and wish to be preserved in the polymer, temperatures in the regime of about 100 to about 120° C., in other embodiments from about 110 to about 145° C. is preferred. The reaction mixture is often dried by addition to the initial reaction mixture of, along with the polar aprotic solvent, a solvent that forms an azeotrope with water. Examples of such solvents include toluene, benzene, xylene, ethylbenzene and chlorobenzene. After removal of residual water by azeotropic drying, the reaction is carried out at the elevated temperatures described above. The reaction is typically conducted for a time period ranging from about 1 hour to about 72 hours, ideally about 1 hour to about 10 hours. Alternatively the bisphenol is converted in an initial step to its dimetallic phenolate salt and isolated and dried. The anhydrous dimetallic salt is used directly in the condensation polymerization reaction with a dihaloaromatic compound in a solvent, either a halogenated aromatic or polar aprotic, at temperatures from about 120 to about 300° C. The reaction may be carried out under ordinary pressure or pressurized conditions.

When halogenated aromatic solvents are used phase transfer catalysts may be employed. Suitable phase transfer catalysts include hexaalkylguanidinium salts and bis-guanidinium salts. Typically the phase transfer catalyst comprises an anionic species such as halide, mesylate, tosylate, tetrafluoroborate, or acetate as the charge-balancing counterion(s). Suitable guanidinium salts include those disclosed in U.S. Pat. Nos. 5,132,423; 5,116,975 and 5,081,298. Other suitable phase transfer catalysts include p-dialkylamino-pyridinium salts, bis-dialkylaminopyridinium salts, bis-quaternary ammonium salts, bis-quaternary phosphonium salts, and phosphazenium salts. Suitable bis-quaternary ammonium and phosphonium salts are disclosed in U.S. Pat. No. 4,554,357. Suitable aminopyridinium salts are disclosed in U.S. Pat. No. 4,460,778; U.S. Pat. No. 4,513,141 and U.S. Pat. No. 4,681,949. Suitable phosphazenium salts are disclosed in U.S. patent application Ser. No. 10/950,874. Additionally, in certain embodiments, the quaternary ammonium and phosphonium salts disclosed in U.S. Pat. No. 4,273,712 may also be used.

The dihalobenzonitrile or mixture of dihalobenzonitriles may be used in substantially equimolar amounts relative to the dihydroxyaromatic compounds or mixture of dihydroxyaromatic compounds used in the reaction mixture. The term “substantially equimolar amounts” means a molar ratio of the dihalobenzonitrile compound(s) to dihydroxyaromatic compound(s) is about 0.85 to about 1.2, preferably about 0.9 to about 1.1, and most preferably from about 0.98 to about 1.02.

After completing the reaction, the polymer may be separated from the inorganic salts, precipitated into a non-solvent and collected by filtration and drying. The drying may be carried out either under vacuum and/or at high temperature, as is known commonly in the art. Examples of non-solvents include water, methanol, ethanol, propanol, butanol, acetone, methyl ethyl ketone, methyl isobutyl ketone, gamma.-butyrolactone, and combinations thereof. Water and methanol are the preferred non-solvents.

The glass transition temperature, T_{g}, of the polymer typically ranges from about 120° C. to about 280° C. in one embodiment, and ranges from about 140° C. to about 200° C. in another embodiment. In some specific embodiments, the T_{g} ranges from about 140° C. to about 190° C., while in other specific embodiments, the T_{g} ranges from about 150° C. to about 180° C.

In particular embodiments, one of a or b may be 0. In specific embodiments, both a and b are 0. In a specific embodiment the polyarylethernitrile, I, is composed of an unsubstituted structural unit (e.g. R¹ and R² are hydrogen).

In some specific embodiments, the polyarylethernitrile comprises structural units of formula IA.

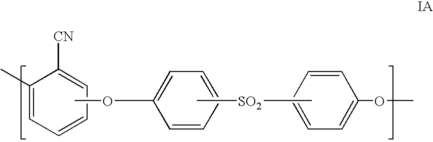

and in some specific embodiments, the polyarylethernitrile comprises structural units of formula IB

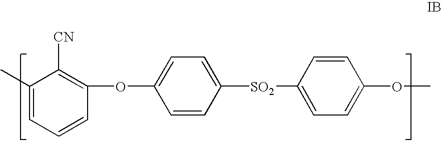

The polyarylethernitrile may be characterized by number average molecular weight (Mₙ) and weight average molecular weight (M_{w}). The various average molecular weights Mₙ and M_{w} are determined by techniques such as gel permeation chromatography, and are known to those of ordinary skill in the art. In one embodiment, the Mₙ of the polymer may be in the range from about 10,000 grams per mole (g/mol) to about 1,000,000 g/mol. In another embodiment, the Mₙ ranges from about 15,000 g/mol to about 200,000 g/mol. In yet another embodiment, the Mₙ ranges from about 20,000 g/mol to about 100,000 g/mol. In still a further embodiment the Mn ranges from about 40,000 g/mol to about 80,000 g/mol

In some embodiments, the hollow fiber membrane comprises a polyarylethernitrile blended with at least one additional polymer, in particular, blended with or treated with one or more agents known for promoting biocompatibility. The polymer may be blended with the polyarylethernitrile to impart different properties such as better heat resistance, biocompatibility, and the like. Furthermore, the additional polymer may be added to the polyarylethernitrile during the membrane formation to modify the morphology of the phase inverted membrane structure produced upon phase inversion, such as asymmetric membrane structures. In addition, at least one polymer that is blended with the polyarylethernitrile may be hydrophilic or hydrophobic in nature. In some embodiments, the polyarylethernitrile is blended with a hydrophilic polymer. A hydrophilic polymer that may be used is polyvinylpyrrolidone (PVP). In addition to, or instead of, polyvinylpyrrolidone, it is also possible to use other hydrophilic polymers which are known to be useful for the production of membranes, such as polyoxazoline, polyethyleneglycol, polypropylene glycol, polyglycolmonoester, copolymers of polyethyleneglycol with polypropylene glycol, water-soluble cellulose derivatives, polysorbate, polyethylene-polypropylene oxide copolymers and polyethyleneimines. PVP may be obtained by polymerizing a N-vinylpyrrolidone using standard addition polymerization techniques known in the art. One such polymerization procedure involves the free radical polymerization using initiators such as azobisisobutyronitrile (AIBN), optionally in the presence of a solvent. PVP is also commercially available under the tradenames PLASDONE® from ISP COMPANY or KOLLIDON® from BASF. Use of PVP in hollow fiber membranes is described in U.S. Pat. Nos. 6,103,117, 6,432,309, 6,432,309, 5,543,465, incorporated herein by reference.

When the membrane comprises a blend of the polyarylethernitrile and PVP, the blend comprises from about 1% to about 80% polyvinylpyrrolidone in one embodiment, preferably 5-50%, and from about 2.5% to about 25% polyvinylpyrrolidone based on total blend components in another embodiment.

PVP may be crosslinked by known methods prior to use to avoid eluting of the polymer with the medium. U.S. Pat. No. 6,432,309, and U.S. Pat. No. 5,543,465, the disclose methods for crosslinking PVP. Some exemplary methods of crosslinking include, but are not limited to, exposing it to heat, radiation such as X-rays, ultraviolet rays, visible radiation, infrared radiation, electron beams; or by chemical methods such as, but not limited to, treating PVP with a crosslinker such as potassium peroxodisulfate, ammonium peroxopersulfate, at temperatures ranging from about 20° C. to about 80° C. in aqueous medium at pH ranges of from about 4 to about 9, and for a time period ranging from about 5 minutes to about 60 minutes. The extent of crosslinking may be controlled, by the use of a crosslinking inhibitor, for example, glycerin, propylene glycol, an aqueous solution of sodium disulfite, sodium carbonate, and combinations thereof.

The hydrophilicity of the polymer blends may be determined by several techniques known to those skilled in the art. One particular technique is that of determination of the contact angle of a liquid such as water on the polymer. It is generally understood in the art that materials exhibiting lower contact angles are considered to be more hydrophilic.

In other embodiments, the polyarylethernitrile is blended with another polymer. Examples of such polymers that may be used include polysulfone, polyether sulfone, polyether urethane, polyamide, polyether-amide, and polyacrylonitrile.

In one particular embodiment, the at least one additional polymer containing an aromatic ring in its backbone and a sulfone moiety as well. Such polymers are described in U.S. Pat. Nos. 4,108,837, 3,332,909, 5,239,043 and 4,008,203. These polymers include polysulfones, polyether sulfones or polyphenylenesulfones or copolymers therefrom.

Examples of commercially available polyethersulfones are RADEL R® (a polyethersulfone made by the polymerization of 4,4′-dichlorodiphenylsulfone and 4,4′-biphenol), RADEL A® (PES) and UDEL® (a polyethersulfone made by the polymerization of 4,4′-dichlorodiphenylsulfone and bisphenol A), both available from Solvay Chemicals.

The membranes for use in the methods and apparatus of the present invention may be made by processes known in the art. Several techniques for membrane formation are known in the art, some of which include, but are not limited to: dry-phase separation membrane formation process in which a dissolved polymer is precipitated by evaporation of a sufficient amount of solvent to form a membrane structure; wet-phase separation membrane formation process in which a dissolved polymer is precipitated by immersion in a non-solvent bath to form a membrane structure; dry-wet phase separation membrane formation process which is a combination of the dry and the wet-phase formation processes; thermally-induced phase-separation membrane formation process in which a dissolved polymer is precipitated or coagulated by controlled cooling to form a membrane structure. Further, after the formation of a membrane, it may be subjected to a membrane conditioning process or a pretreatment process prior to its use in a separation application. Representative processes may include thermal annealing to relieve stresses or pre-equilibration in a solution similar to the feed stream the membrane will contact.

Without being bound to theory, it is understood that dialysis works on the principle of the diffusion of solutes across a porous membrane. During dialysis, a feed fluid that is to be purified passes on one side of a membrane, and a dialysis fluid is passed on the other side of the membrane. By altering the composition of the dialysis fluid, a concentration gradient of undesired solutes is formed such that there is a lesser concentration of the undesired solute in the dialysis fluid as compared to the feed fluid. Thus, the undesired solutes will pass through the membrane while the rest of the solutes pass through with the now purified fluid. The membrane may also be designed to have specific pore sizes so that solutes having sizes greater than the pore sizes may not be able to pass through. Pore size refers to the radius of pores in the active layer of the membrane. Pore size of membranes according to the present invention ranges from about 0.5 to about 100 nm, preferably from about 4 to about 50 nm, more preferably from about 4 to about 25 nm, even more preferably from about 4 to about 15 nm, and even more preferably from about 5.5 to about 9.5 nm.

A dialysis apparatus generally comprises a plurality of hollow fiber (HF) membranes that are stacked or bundled together to form a module. The fluid to be purified is fed into the feed line, which is then allowed to pass through the dialysis lines, while coming in contact with the membranes. On the other side of the membranes, the dialysis fluid is allowed to pass. The feed fluid may also be pumped under pressure, thus causing a pressure differential between the feed fluid and the dialysis fluid. During the contact, the concentration gradient between the feed fluid and the dialysis fluid and the membrane pore size causes undesirable solutes to diffuse through the membranes, while the fluid passes through towards the fluid outlet as the permeate, and the undesirable solutes come out through the retentate line. The solutes in the dialysis fluid may be chosen in such a way to effect efficient separation of only specific solutes from the feed fluid.

General methods for preparation of porous hollow fibers and dialysis modules is described in U.S. Pat. No. 6,103,117 incorporated herein by reference. Hemofiltration/hemodialysis modules and their manufacture are also described in U.S. Pat. No. 5,202,023, which is incorporated herein by reference. Fabrication of hemofiltration/hemodialysis modules membranes is also described in U.S. Pat. Nos. 4,874,522, 5,232,6015,762,7985,879,554 and 6,103,117, all of which are incorporated herein by reference.

Hemodialysis is one instance of dialysis wherein blood is purified by using a hemodialysis apparatus. In hemodialysis, a patient's blood is passed through a system of tubing via a machine to the membrane, which has dialysis fluid running on the other side. The cleansed blood is then returned via the circuit back to the body. It is one object of the invention to provide hollow fiber membranes for a hemodialysis unit.

### Definitions

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, furanyl, thienyl, naphthyl, and biphenyl radicals. The aromatic aryl radical may be substituted. Subtituents include a member or members selected from the group consisting of F, Cl, Br, I, alkyl, aryl, amide, sulfonamide, hydroxyl, aryloxy, alkoxy, thioalkoxy, thioaryloxy, carbonyl, sulfonyl, carboxylate, carboxylic ester, sulfone, phosphonate, sulfoxide, urea, carbamate, amine, phosphinyl, nitro, cyano, acylhydrazide, hydrazide, imide, imine, amidates, amidines, oximes, peroxides, diazo, azide and the like.

As used herein the term “aliphatic radical” refers to an organic radical having a valence of at least one consisting of a linear or branched array of atoms both cyclic and non-cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” organic radicals substituted with a wide range of functional groups such as alkyl groups, alkenyl groups, alkynyl groups, F, Cl, Br, I, amide, sulfonamide, hydroxyl, aryloxy, alkoxy, thioalkoxy, thioaryloxy, carbonyl, sulfonyl, carboxylate, carboxylic ester, sulfone, phosphonate, sulfoxide, urea, carbamate, amine, phosphinyl, nitro, cyano, acylhydrazide, hydrazide, imide, imine, amidates, amidines, oximes, peroxides, diazo, azide, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. The polymer may contain or be further functionalized with hydrophilic groups, including hydrogen-bond acceptors that have overall, electrically neutral charge.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Asymmetric membrane refers to a membrane that is constituted of two or more structural planes of non-identical morphologies.

Dialysis refers to a process effected by one or more membranes in which transport is driven primarily by pressure differences across the thickness of the one or more membrane.

Hemodialysis refers to a dialysis process in which biologically undesired and/or toxic solutes, such as metabolites and by-products are removed from blood.

Molecular-weight cutoff refers to the molecular weight of a solute below which about 90% of the solute is rejected for a given membrane.

### EXAMPLES

General Methods and Procedures

Chemicals were purchased from Aldrich Chemical Company and Sloss Industries, and used as received, unless otherwise noted. All reactions with air- and/or water-sensitive compounds were carried out under dry nitrogen using standard Schlenk line techniques. NMR spectra were recorded on a Bruker Avance 400 (¹H, 400 MHz) spectrometer and referenced versus residual solvent shifts. Molecular weights are reported as number average (Mₙ) or weight average (M_{w}) molecular weight and were determined by gel permeation chromatography (GPC) analysis on a Perkin Elmer Series 200 instrument equipped with UV detector. Polystyrene molecular weight standards were used to construct a broad standard calibration curve against which polymer molecular weights were determined. The temperature of the gel permeation column (Polymer Laboratories PLgel 5 μm MIXED-C, 300×7.5 mm) was 40° C. and the mobile phase was chloroform with isopropanol (3.6% v/v). Polymer thermal analysis was performed on a Perkin Elmer DSC7 equipped with a TAC7/DX thermal analyzer and processed using Pyris Software. Glass transition temperatures were recorded on the second heating scan.

Contact angle measurements were taken on a VCA 2000 (Advanced Surface Technology, Inc.) instrument using VCAoptima Software for evaluation. Polymer films were obtained from casting a thin film of a 20 wt. % DMAC solution of the appropriate polymer) onto a clean glass slide and evaporating the solvent. Advancing contact angles with water (73 Dynes/cm) were determined on both sides of the film (facing air and facing glass slide).

### Example 1

### Polyarylethemitrile Preparation

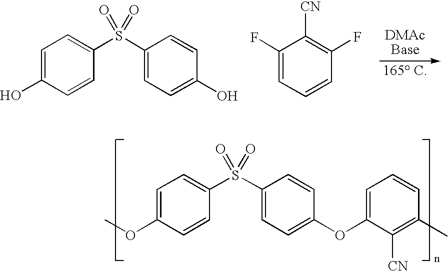

Under nitrogen atmosphere N,N-dimethylacetamide (DMAc) (500 mL) and K₂CO₃ (400.08 g, 2.8949 mol) were charged into a 5000 mL-reactor. Bisphenol-S (361.90 g, 1.4460 mol) was added and rinsed in with DMAc (1100 mL). Over the course of 2 days about 2350 mL of toluene was added in portions and distilled out to dry the reaction mixture. Then, 2,6-difluorobenzonitrile (196.85 g, 1.4151 mol) plus more toluene (525 mL) was added. During the subsequent polymerization toluene kept distilling at a constant rate (˜2.5 ml/min). After 5 h, the weight average molecular weight (Mw) was 80,000 g/mol (Polydispersivity=1.6) was high enough and the mixture was diluted with DMAc (3200 mL) and the polymer was drained from the reactor, precipitated into water, filtered and rinsed with water. The resulting white fluffy powder was reslurried with water, filtered and slurried again with methanol. After filtration and drying in the vacuum oven 450 g (89% yield) of a fluffy white powder was obtained.
DSC: T_{g}=227° C.
TGA: 1-2% weight loss up to 450° C., decomposition starts at 460° C., 52% wt loss at 900° C.
Contact angle: 740 facing air, 43° facing glass slide

### Comparative Example 1

### Polyethersulfone Contact Angle

A polyethersulfone film (Radel A) was prepared by the method described above and the contact angle measured.
Contact angle: 77° facing air, 56° facing glass slide

### Example 2

Preparation of a Porous Polyarylethernitrile Membrane: The polyarylethernitrile from Example 1 was dissolved in NMP to produce a 20 weight % solids solution. The solution was cast onto a glass plate using a 10 mil casting knife. Porous membranes were produced by immersing the films immediately into water at room temperature. Scanning electron micrograph (SEM) of the sample was obtained and demonstrated that porous membranes were formed from the polycyanoether nitrile.

### Example 3

To a 20 wt. % solution of Example 1 was added 20 weight % polyvinylpyrollidinone (Number Average Molecular Weight (Mn)=100,000 g/mol). The solution was cast onto a glass plate using a 10 mil casting knife. Porous membranes were produced by immersing the films immediately into water at room temperature. Scanning electron micrographs (SEM) of the sample was obtained and demonstrated that porous membranes were formed from the polycyanoethernitrile/polyvinylpyrollidinone blend.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for hemodialysis and hemofiltration, said method comprising contacting blood with a hollow fiber membrane comprising a polyarylethernitrile having structural units of formula I 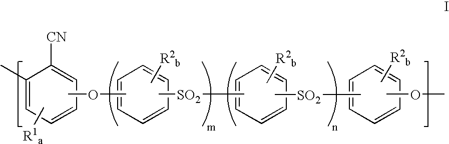
wherein
R¹ and R² are independently H, nitro, a C₁-C₁₂ aliphatic radical, a C₃-C₁₂ aromatic radical, or a combination thereof;
a is 0, 1, 2 or 3;
b is 0, 1, 2, 3 or 4; and
m and n are independently 0 or 1.

2. A method according to claim 1, wherein the hollow fiber membrane comprises a blend of the polyarylethernitrile with at least one other polymer or oligomer.

3. A method according to claim 1, wherein the hollow fiber membrane additionally comprises at least one hydrophilic polymer.

4. A method according to claim 2, wherein the at least one hydrophilic polymer comprises polyvinylpyrrolidone.

5. A method according to claim 2, wherein the hollow fiber membrane comprises from about 1% to about 80% polyvinylpyrrolidone.

6. A method according to claim 2, wherein the hollow fiber membrane comprises from about 5% to about 50% polyvinylpyrrolidone.

7. A method according to claim 2, wherein the hollow fiber membrane comprises from about 2.5% to about 25% polyvinylpyrrolidone.

8. A method according to claim 1, wherein the polyarylethernitrile comprises structural units of formula IA

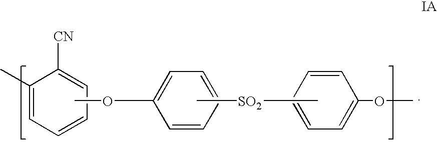

9. A method according to claim 1, wherein the polyarylethernitrile comprises structural units of formula IB

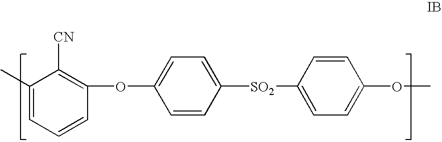

10. A method according to claim 1, wherein the polyarylethernitrile is derived from 2,6-dichlorobenzonitrile, 2,4-dichlorobenzonitrile 2,6-difluorobenzonitrile, 2,4-difluorobenzonitrile, or a combination thereof.

11. A dialysis apparatus comprising a plurality of porous hollow fiber membranes comprising a polyarylethernitrile having structural units of formula I 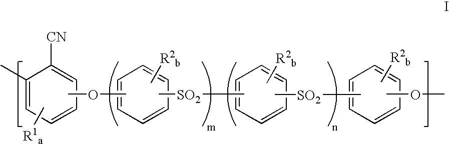
wherein
R¹ and R² are independently H, nitro, a C₁-C₁₂ aliphatic radical, a C₃-C₁₂ aromatic radical, or a combination thereof;
a is 0, 1, 2 or 3;
b is 0, 1, 2, 3 or 4; and
m and n are independently 0 or 1.

12. A dialysis apparatus according to claim 11, wherein the hollow fiber membrane comprises a blend of the polyarylethernitrile with at least one other polymer or oligomer.

13. A dialysis apparatus according to claim 11, wherein the hollow fiber membrane additionally comprises at least one hydrophilic polymer.

14. A dialysis apparatus according to claim 12, wherein the at least one hydrophilic polymer comprises polyvinylpyrrolidone.

15. A dialysis apparatus according to claim 12, wherein the blend comprises from about 1% to about 80% polyvinylpyrrolidone.

16. A dialysis apparatus according to claim 12, wherein the blend comprises from about 5% to about 50% polyvinylpyrrolidone.

17. A dialysis apparatus according to claim 12, wherein the blend comprises from about 2.5% to about 25% polyvinylpyrrolidone.

18. A dialysis apparatus according to claim 11, wherein the polyarylethernitrile comprises structural units of formula IA

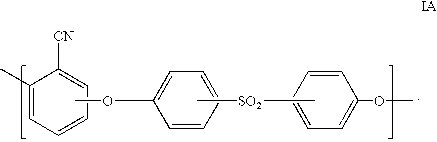

19. A dialysis apparatus according to claim 11, wherein the polyarylethernitrile comprises structural units of formula IB

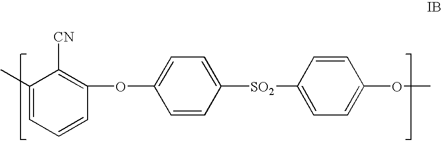

20. A dialysis apparatus according to claim 11, wherein the polyarylethernitrile is derived from 2,6-dichlorobenzonitrile, 2,4-dichlorobenzonitrile 2,6-difluorobenzonitrile, 2,4-difluorobenzonitrile, or a combination thereof.

21. A porous membrane for hemodialysis and hemofiltration comprising a polyarylethernitrile having structural units of formula I 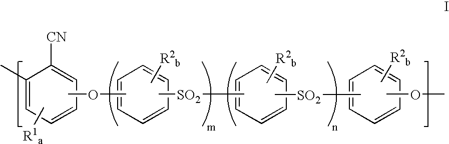
wherein
R¹ and R² are independently H, nitro, a C₁-C₁₂ aliphatic radical, a C₃-C₁₂ aromatic radical, or a combination thereof;
a is 0, 1, 2 or 3;
b is 0, 1, 2, 3 or 4; and
m and n are independently 0 or 1.

22. A porous membrane according to claim 21, wherein the hollow fiber membrane comprises a blend of the polyarylethernitrile with at least one other polymer or oligomer.

23. A porous membrane according to claim 21, wherein the hollow fiber membrane additionally comprises at least one hydrophilic polymer.

24. A porous membrane according to claim 22, wherein the at least one hydrophilic polymer comprises polyvinylpyrrolidone.

25. A porous membrane according to claim 22, wherein the hollow fiber membrane comprises from about 1% to about 80% polyvinylpyrrolidone.

26. A porous membrane according to claim 22, wherein the hollow fiber membrane comprises from about 5% to about 50% polyvinylpyrrolidone.

27. A porous membrane according to claim 22, wherein the hollow fiber membrane comprises from about 2.5% to about 25% polyvinylpyrrolidone.

28. A porous membrane according to claim 21, wherein the polyarylethernitrile comprises structural units of formula IA

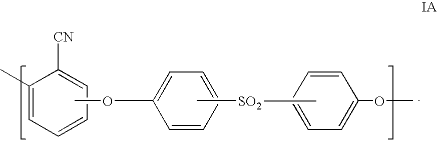

29. A porous membrane according to claim 21, wherein the polyarylethernitrile comprises structural units of formula IB

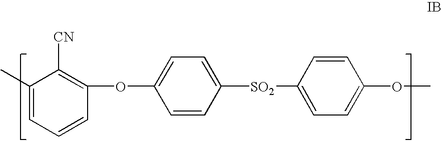

30. A porous membrane according to claim 21, wherein the polyarylethernitrile is derived from 2,6-dichlorobenzonitrile, 2,4-dichlorobenzonitrile 2,6-difluorobenzonitrile, 2,4-difluorobenzonitrile, or a combination thereof.

31. A porous membrane according to claim 21, having a pore size ranging from about 0.5 to about 100 nm.

32. A porous membrane according to claim 21, having a pore size ranging from about 4 to about 50 nm.

33. A porous membrane according to claim 21, having a pore size ranging from about 4 to about 25 nm.

34. A porous membrane according to claim 21, having a pore size ranging from about 4 to about 15 nm.

35. A porous membrane according to claim 21, having a pore size ranging from about 5.5 to about 9.5 nm.
